(19) United States
(12) Patent Application Publication
(10) Pub. No.: US 2025/0210841 A1
(43) Pub. Date: Jun. 26, 2025

(54) DUAL-BAND WAVEGUIDE FILTER

(71) Applicant: WCI Co., Ltd, Bucheon-si (KR)

(72) Inventor: Chan Joong KWON, Incheon (KR)

(21) Appl. No.: 18/989,229

(22) Filed: Dec. 20, 2024

(30) Foreign Application Priority Data
Dec. 21, 2023 (KR) 10-2023-0188932
Jul. 12, 2024 (KR) 10-2024-0092625

(51) Int. Cl. H01P 1/208

(52) U.S. Cl. CPC H01P 1/2084

(57) ABSTRACT

One embodiment of the present disclosure provides a dual-band waveguide filter including: a filter housing; an input common junction including an input port hole positioned at one side of the filter housing; an output common junction including an output port hole positioned at the other side of the filter housing and positioned to be opposite to the input port hole; and two filters positioned to be spaced apart from each other at a predetermined gap in an alignment direction of the input port hole and the output port hole in the filter housing and connected by the input common junction and the output common junction, in which a signal is inputted to the input port hole, and a signal is outputted from the output port hole.

### CROSS-REFERENCE TO RELATED APPLICATION

This application claims priority to and the benefit of Korean Patent Application No. 10-2023-0188932 filed in the Korean Intellectual Property Office on Dec. 21, 2023, and Korean Patent Application No. 10-2024-0092625 filed in the Korean Intellectual Property Office on Jul. 12, 2024, the entire contents of which are incorporated herein by reference.

### BACKGROUND OF THE INVENTION

### (a) Field of the Invention

The present disclosure relates to a dual-band waveguide filter and a duplexer.

### (b) Description of the Related Art

As wireless mobile communication services are popularized, there is an increasing demand for wireless relay devices. With the rapidly increasing demand for wide-area communication systems in high-frequency bands, there is a need for small-scale duplexers that may operate even with high power and have temperature stability related to frequencies.

Korean Patent No. KR 10-2495987 B1 discloses a single-element ceramic waveguide duplexer. In this case, a receiving port filter includes a receiving port, and a transmitting port filter includes a transmitting port.

However, in addition, there is a need for various structures that constitute a dual band by using a single filter.

### SUMMARY OF THE INVENTION

The present disclosure also attempts to provide a dual-band waveguide filter and a duplexer, in which two filters for outputting two or more bands are integrated, such that a dual band is implemented by a single waveguide filter. One aspect of the present disclosure provides a dual-band waveguide filter including: a filter housing; an input common junction including an input port hole positioned at one side of the filter housing; an output common junction including an output port hole positioned at the other side of the filter housing and positioned to be opposite to the input port hole; and two filters positioned to be spaced apart from each other at a predetermined gap in an alignment direction of the input port hole and the output port hole in the filter housing and connected by the input common junction and the output common junction, in which a signal is inputted to the input port hole, and a signal is outputted from the output port hole.

The two filters may include a first filter and a second filter, and the input common junction and the output common junction may each include: a first partial region provided on the filter housing and extending in a direction from the first filter toward the second filter; and a second partial region provided on the filter housing and extending to be opposite to the first partial region in a direction from the second filter toward the first filter.

The filter housing may include an opening portion perforated between the two filters, and the opening portion may have a predetermined length and a predetermined width in a longitudinal direction of an imaginary line that passes through a center of the input port hole and a center of the output port hole.

The two filters may each include a plurality of resonance blocks.

The plurality of resonance blocks may each include a resonance groove provided in the form of a groove having a predetermined depth from an upper surface of the filter housing.

Another aspect of the present disclosure provides a dual-band waveguide filter including: a filter housing; a first filter including a plurality of first resonance blocks positioned at one side in the filter housing; a second filter including a plurality of second resonance blocks positioned at the other side opposite to one side in the filter housing; an input common junction positioned in a first region between the first filter and the second filter in the filter housing and including an input port to which a signal is inputted; and an output common junction positioned in a second region between the first filter and the second filter in the filter housing and including an output port from which a signal is outputted, in which the first region and the second region are positioned to be spaced apart from each other.

The input common junction and the output common junction may each include: a first partial region provided on the filter housing and extending in a direction from the first filter toward the second filter; and a second partial region provided on the filter housing and extending to be opposite to the first partial region in a direction from the second filter toward the first filter.

The first filter and the second filter may be spaced apart from each other at a predetermined gap.

The filter housing may include an opening portion perforated between the first filter and the second filter, and the opening portion may have a predetermined length and a predetermined width in a longitudinal direction of an imaginary line that passes through a center of the input port hole and a center of the output port hole.

The plurality of first resonance blocks and the plurality of second resonance blocks may each include a resonance groove provided in the form of a groove having a predetermined depth from an upper surface of the filter housing.

Still another aspect of the present disclosure provides a duplexer including: a filter housing; a common junction including an antenna port hole positioned at one side of the filter housing; a transmitting filter positioned in one direction based on a centerline, which passes through a center of the antenna port hole in the filter housing, the transmitting filter including a transmitting port hole; and a receiving filter positioned to be spaced apart from the transmitting filter at a predetermined gap in the other direction opposite to one direction based on the centerline, the receiving filter including a receiving port hole.

The filter housing may include an opening portion perforated between the transmitting filter and the receiving filter, and the opening portion may have a predetermined length and a predetermined width in a longitudinal direction of the centerline.

The transmitting filter and the receiving filter may each include a plurality of resonance blocks.

The plurality of resonance blocks may each include a resonance groove provided in the form of a groove having a predetermined depth from an upper surface of the filter housing.

According to the present disclosure, the dual-band waveguide filter may be the single filter and output two or more bands.

According to the present disclosure, the number of stages of the two filters included in the single waveguide filter may be variously implemented.

### BRIEF DESCRIPTION OF THE DRAWINGS

FIG. 1 is a top plan view illustrating a waveguide filter according to an embodiment.

FIG. 2 is an enlarged view illustrating an input common junction and an output common junction illustrated in FIG. 1.

FIG. 3 is a perspective view of a waveguide filter according to another embodiment.

FIG. 4 is a perspective view of a waveguide filter according to still another embodiment.

FIG. 5 is a graph for explaining electrical properties of the waveguide filter according to the embodiment.

FIG. 6 is a top plan view of a duplexer according to the embodiment.

### DETAILED DESCRIPTION OF THE EMBODIMENTS

Hereinafter, embodiments disclosed in the present specification will be described in detail with reference to the accompanying drawings. The same or similar constituent elements are assigned with the same or similar reference numerals, and the repetitive description thereof will be omitted. The suffixes ‘module’, ‘unit’, ‘part’, and/or ‘portion’ used to describe constituent elements in the following description are used together or interchangeably in order to facilitate the description, but the suffixes themselves do not have distinguishable meanings or functions. In addition, in the description of the embodiment disclosed in the present specification, the specific descriptions of publicly known related technologies will be omitted when it is determined that the specific descriptions may obscure the subject matter of the embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

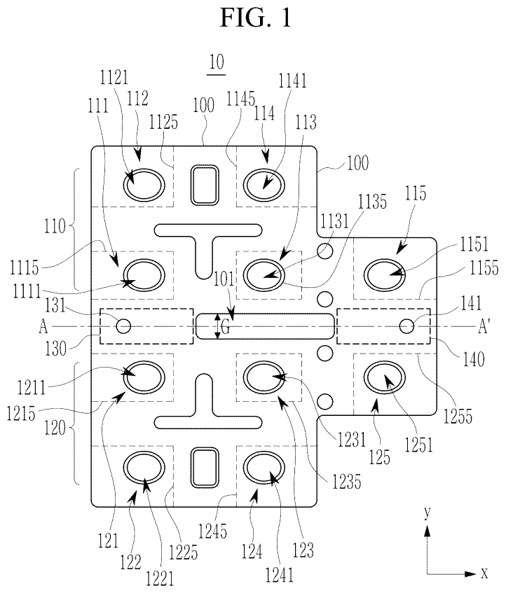

FIG. 1 is a top plan view illustrating a waveguide filter according to an embodiment.

A waveguide filter 10 may be a single filter, i.e., a dual-band filter having a dual band as a passband. Hereinafter, the waveguide filter 10 according to the embodiment is a dual-band waveguide filter.

The waveguide filter 10 may include a filter housing 100, a first filter 110, a second filter 120, an input common junction 130, an input port hole 131, an output common junction 140, and an output port hole 141.

The waveguide filter 10 according to the embodiment is a dual-band filter and includes the input port hole 131 and the output port hole 141 one by one. Therefore, the waveguide filter 10 may require a junction connected to filters of two bands from the single input port hole 131, and a junction connected to the single output port hole 141 from the filters of the two bands. The waveguide filter 10 according to the embodiment may include the above-mentioned junctions, i.e., the input common junction 130 and the output common junction 140. The input common junction 130 may be a region connected to the filters of the two bands from the single input port hole 131. The output common junction 140 may be a region connected to the single output port hole 141 from the filters of the two bands.

The input common junction 130 may include the input port hole 131 and be positioned in one region between the first filter 110 and the second filter 120 in the filter housing 100. A signal may be inputted to the input port hole 131. The input common junction 130 may include a region connected to the first filter 110 and the second filter 120 from the input port hole 131. The input port hole 131 may be positioned at one side of the filter housing 100 (e.g., based on a negative x-axis direction in FIG. 1).

The output common junction 140 may include the output port hole 141 and be positioned in the other region between the first filter 110 and the second filter 120 in the filter housing 100. A signal may be outputted from the output port hole 141. The output port hole 141 may be a point at which a transmitting end Rx and a receiving end Tx branch off from a single port. The output common junction 140 may include a region connected to the output port hole 141 from the first filter 110 and the second filter 120. The output port hole 141 may be positioned at the other side of the filter housing 100 (e.g., based on a positive x-axis direction in FIG. 1) and positioned to be opposite to the input port hole 131.

The input port hole 131 and the output port hole 141 are perforated.

With reference to FIG. 1, the filter housing 100 may include an opening portion 101. The opening portion 101 may be a perforated region between the first filter 110 and the second filter 120. The opening portion 101 may position the first filter 110 and the second filter 120 at a predetermined gap G. The input common junction 130 and the output common junction 140 may be positioned to be spaced apart from each other by means of the opening portion 101.

The opening portion 101 may have a predetermined length and a predetermined width in a longitudinal direction of a centerline A-A′. In this case, the centerline A-A′ may be an imaginary line that passes through a center of the input port hole 131 and a center of the output port hole 141 on an upper surface of the filter housing 100. In the example in FIG. 1, the centerline A-A′ is parallel to the x-axis direction.

The first filter 110 and the second filter 120 may be positioned in the filter housing 100 and spaced apart from each other at the predetermined gap G in an alignment direction of the input port hole 131 and the output port hole 141. The first filter 110 and the second filter 120 may be connected by the input common junction 130 and the output common junction 140.

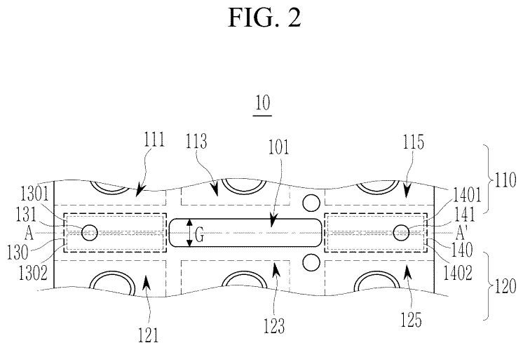

FIG. 2 is an enlarged view illustrating the input common junction and the output common junction illustrated in FIG. 1.

With reference to FIG. 2, the input common junction 130 may include a partial region 1301 and a partial region 1302. The partial region 1301 may be a region on the filter housing 100 extending in a direction from the first filter 110 toward the second filter 120. The partial region 1302 may be a region on the filter housing 100 positioned to be opposite to the partial region 1301 in a direction from the second filter 120 toward the first filter 110. The input port hole 131 may be provided between the partial region 1301 and the partial region 1302.

With reference to FIG. 2, the output common junction 140 may include a partial region 1401 and a partial region 1402. The partial region 1401 may be a region on the filter housing 100 extending in the direction from the first filter 110 toward the second filter 120. The partial region 1402 may be a region on the filter housing 100 positioned to be opposite to the partial region 1401 in the direction from the second filter 120 toward the first filter 110. The output port hole 141 may be provided between the partial region 1401 and the partial region 1402.

With reference to FIGS. 1 and 2, the first filter 110 may include a plurality of resonance blocks 111, 112, 113, 114, and 115. The plurality of resonance blocks 111, 112, 113, 114, and 115 may be respectively formed by a plurality of resonance grooves 1111, 1121, 1131, 1141, and 1151. The plurality of resonance grooves 1111, 1121, 1131, 1141, and 1151 may each be positioned on the upper surface of the filter housing 100 and provided in the form of a groove having a predetermined depth from the upper surface of the filter housing 100. The resonance block 111 may include the resonance groove 1111, the resonance block 112 may include the resonance groove 1121, the resonance block 113 may include the resonance groove 1131, the resonance block 114 may include the resonance groove 1141, and the resonance block 115 may include the resonance groove 1151.

The plurality of resonance blocks 111, 112, 113, 114, and 115 may be positioned at one side (e.g., based on a positive y-axis direction in FIG. 1) based on the centerline A-A′ of the filter housing 100.

The second filter 120 may include a plurality of resonance blocks 121, 122, 123, 124, and 125. The plurality of resonance blocks 121, 122, 123, 124, and 125 may be respectively formed by a plurality of resonance grooves 1211, 1221, 1231, 1241, and 1251. The plurality of resonance grooves 1211, 1221, 1231, 1241, and 1251 may each be positioned on the upper surface of the filter housing 100 and provided in the form of a groove having a predetermined depth from the upper surface of the filter housing 100. The resonance block 121 may include the resonance groove 1211, the resonance block 122 may include the resonance groove 1221, the resonance block 123 may include the resonance groove 1231, the resonance block 124 may include the resonance groove 1241, and the resonance block 125 may include the resonance groove 1251.

The plurality of resonance blocks 121, 122, 123, 124, and 125 may be positioned at the other side (e.g., based on a negative y-axis direction in FIG. 1) opposite to one side (e.g., based on the positive y-axis direction in FIG. 1) based on the centerline A-A′ of the filter housing 100.

In the present specification, the resonance blocks may be separated by a partition wall and/or a partition slot provided between the adjacent resonance blocks. The resonance blocks separated by the partition wall and/or the partition slot do not necessarily need to be separated physically and completely. For convenience of description, the resonance block included in the drawings may exclude the partition wall and the partition slot. The size and resonance properties of each of resonance blocks may vary depending on the sizes (widths and lengths) and the positions of the partition wall and/or the partition slot.

The inside of each of the resonance blocks may be filled with a dielectric material, and ceramic or air may be used as the dielectric material. However, the dielectric material is not necessarily limited to ceramic or air, and other dielectric materials may of course be used.

FIG. 1 illustrates that the plurality of resonance blocks 111, 112, 113, 114, and 115 and the plurality of resonance blocks 121, 122, 123, 124, and 125 are disposed symmetrically with respect to the centerline A-A′. However, this configuration is provided for convenience of description, and the present disclosure is not limited thereto. In any embodiment, the number of resonance blocks included in the first filter may be different from the number of resonance blocks included in the second filter. Even though the number of resonance blocks included in the first filter and the number of resonance blocks included in the second filter are equal to each other, the resonance blocks may not disposed symmetrically with respect to the centerline A-A′.

FIG. 1 illustrates that the first filter 110 and the second filter 120 each include five resonance blocks. However, this configuration is provided for convenience of description, and the present disclosure is not limited thereto. The first filter 110 and the second filter 120 according to the embodiment may each include two or more resonance blocks.

FIGS. 1 and 2 illustrate dotted lines 1115, 1125, 1135, 1145, 1155, 1215, 1225, 1235, 1245, and 1255 for distinguishing between the plurality of resonance blocks 111, 112, 113, 114, and 115 and the plurality of resonance blocks 121, 122, 123, 124, and 125. However, the dotted lines are provided to explain the embodiment and do not limit structures, shapes, and the like of the resonance blocks.

The number of stages of each of the first filter 110 and the second filter 120 may correspond to the number of resonance blocks respectively included in the first filter 110 and the second filter 120. For example, as illustrated in FIG. 1, the number of filter stages of each of the first filter 110 and the second filter 120 may be five. The number of stages of the waveguide filter according to any embodiment may differ from the number of stages of the waveguide filter 10 illustrated in FIG. 1 in accordance with the determination by those skilled in the art. The arrangements, shapes, and the like of the resonance blocks included in the waveguide filter according to any embodiment may differ from the arrangements, shapes, and the like of the resonance blocks included in the waveguide filter 10 illustrated in FIG. 1.

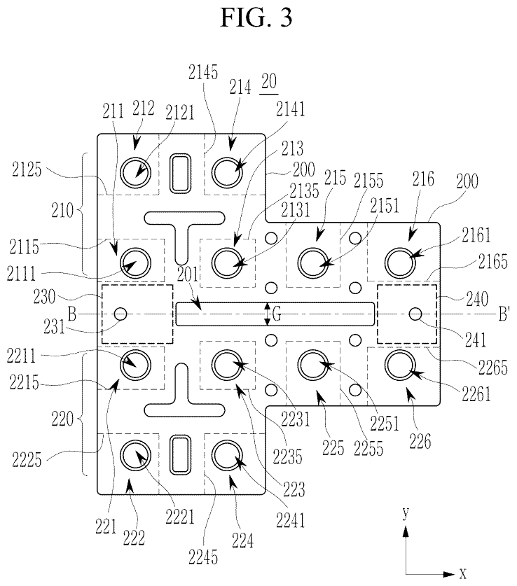

FIG. 3 is a perspective view of a waveguide filter according to another embodiment.

With reference to FIG. 3, a waveguide filter 20 may include a filter housing 200, a first filter 210, a second filter 220, an input common junction 230, an input port hole 231, an output common junction 240, and an output port hole 241.

Hereinafter, the description of the components of the waveguide filter, which are identical to the above-mentioned components, may be omitted. Hereinafter, the description of the first filter 210, the second filter 220, the input common junction 230, the input port hole 231, the output common junction 240, and the output port hole 241, which are not particularly mentioned, may be similar to the description of the first filter 110, the second filter 120, the input common junction 130, the input port hole 131, the output common junction 140, and the output port hole 141.

The input port hole 231 may be positioned at one side of the filter housing 200 (e.g., based on a negative x-axis direction in FIG. 3). The output port hole 241 may be positioned at the other side of the filter housing 200 (e.g., based on a positive x-axis direction in FIG. 3) and positioned to be opposite to the input port hole 231.

The input port hole 231 and the output port hole 241 are perforated.

With reference to FIG. 3, the filter housing 200 may include an opening portion 201. The opening portion 201 may be a perforated region between the first filter 210 and the second filter 220. The opening portion 201 may position the first filter 210 and the second filter 220 at a predetermined gap G. The opening portion 201 may have a predetermined width in a longitudinal direction of a centerline B-B′. In this case, the centerline B-B′ may be an imaginary line that passes through a center of the input port hole 231 and a center of the output port hole 241 on an upper surface of the filter housing 200. In the example in FIG. 3, the centerline B-B′ is parallel to the x-axis direction.

The first filter 210 and the second filter 220 may be positioned in the filter housing 200 and spaced apart from each other at the predetermined gap G in an alignment direction of the input port hole 231 and the output port hole 241. The first filter 210 and the second filter 220 may be connected by the input common junction 230 and the output common junction 240.

The first filter 210 may include a plurality of resonance blocks 211, 212, 213, 214, 215, and 216. The plurality of resonance blocks 211, 212, 213, 214, 215, and 216 may be respectively formed by a plurality of resonance grooves 2111, 2121, 2131, 2141, 2151, and 2161. The plurality of resonance grooves 2111, 2121, 2131, 2141, 2151, and 2161 may each be positioned on the upper surface of the filter housing 200 and provided in the form of a groove having a predetermined depth from the upper surface of the filter housing 200. The resonance block 211 may include the resonance groove 2111, the resonance block 212 may include the resonance groove 2121, the resonance block 213 may include the resonance groove 2131, the resonance block 214 may include the resonance groove 2141, the resonance block 215 may include the resonance groove 2151, and the resonance block 216 may include the resonance groove 2161.

The plurality of resonance blocks 211, 212, 213, 214, 215, and 216 may be positioned at one side (e.g., based on a positive y-axis direction in FIG. 3) based on the centerline B-B′ of the filter housing 200.

The second filter 220 may include a plurality of resonance blocks 221, 222, 223, 224, 225, and 226. The plurality of resonance blocks 221, 222, 223, 224, 225, and 226 may be respectively formed by a plurality of resonance grooves 2211, 2221, 2231, 2241, 2251, and 2261. The plurality of resonance grooves 2211, 2221, 2231, 2241, 2251, and 2261 may each be positioned on the upper surface of the filter housing 200 and provided in the form of a groove having a predetermined depth from the upper surface of the filter housing 200. The resonance block 221 may include the resonance groove 2211, the resonance block 222 may include the resonance groove 2221, the resonance block 223 may include the resonance groove 2231, the resonance block 224 may include the resonance groove 2241, the resonance block 225 may include the resonance groove 2251, and the resonance block 226 may include the resonance groove 2261.

The plurality of resonance blocks 221, 222, 223, 224, 225, and 226 may be positioned at the other side (e.g., based on a negative y-axis direction in FIG. 3) opposite to one side (e.g., based on the positive y-axis direction in FIG. 3) based on the centerline B-B′ of the filter housing 200.

FIG. 3 illustrates dotted lines 2115, 2125, 2135, 2145, 2155, 2165, 2215, 2225, 2235, 2245, 2255, and 2265 for distinguishing between the plurality of resonance blocks 211, 212, 213, 214, 215, and 216 and the plurality of resonance blocks 221, 222, 223, 224, 225, and 226. However, the dotted lines are provided to explain the embodiment and do not limit structures, shapes, and the like of the resonance blocks.

The number of filter stages of each of the first filter 210 and the second filter 220 illustrated in FIG. 3 may be six.

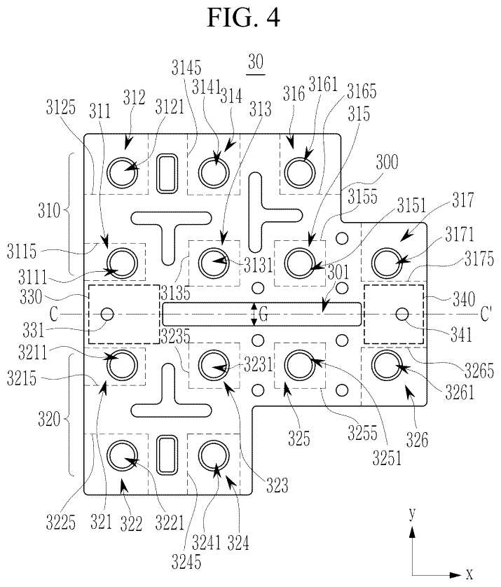

FIG. 4 is a perspective view of a waveguide filter according to still another embodiment.

With reference to FIG. 4, a waveguide filter 30 may include a filter housing 300, a first filter 310, a second filter 320, an input common junction 330, an input port hole 331, an output common junction 340, and an output port hole 341. Hereinafter, the description of the components of the waveguide filter, which are identical to the above-mentioned components, may be omitted. Hereinafter, the description of the first filter 310, the second filter 320, the input common junction 330, the input port hole 331, the output common junction 340, and the output port hole 341, which are not particularly mentioned, may be similar to the description of the first filter 110, the second filter 120, the input common junction 130, the input port hole 131, the output common junction 140, and the output port hole 141.

The input port hole 331 may be positioned at one side of the filter housing 300 (e.g., based on a negative x-axis direction in FIG. 4). The output port hole 341 may be positioned at the other side of the filter housing 300 (e.g., based on a positive x-axis direction in FIG. 4) and positioned to be opposite to the input port hole 331.

The input port hole 331 and the output port hole 341 are perforated.

With reference to FIG. 4, the filter housing 300 may include an opening portion 301. The opening portion 301 may be a perforated region between the first filter 310 and the second filter 320. The opening portion 301 may position the first filter 310 and the second filter 320 at a predetermined gap G. The opening portion 301 may have a predetermined width in a longitudinal direction of a centerline C-C′. In this case, the centerline C-C′ may be an imaginary line that passes through a center of the input port hole 331 and a center of the output port hole 341 on an upper surface of the filter housing 300. In the example in FIG. 4, the centerline C-C′ is parallel to the x-axis direction.

The first filter 310 and the second filter 320 may be positioned in the filter housing 300 and spaced apart from each other at the predetermined gap G in an alignment direction of the input port hole 331 and the output port hole 341. The first filter 310 and the second filter 320 may be connected by the input common junction 330 and the output common junction 340.

The first filter 310 may include a plurality of resonance blocks 311, 312, 313, 314, 315, 316, and 317. The plurality of resonance blocks 311, 312, 313, 314, 315, 316, and 317 may be respectively formed by a plurality of resonance grooves 3111, 3121, 3131, 3141, 3151, 3161, and 3171. The plurality of resonance grooves 3111, 3121, 3131, 3141, 3151, 3161, and 3171 may each be positioned on the upper surface of the filter housing 300 and provided in the form of a groove having a predetermined depth from the upper surface of the filter housing 300. The resonance block 311 may include the resonance groove 3111, the resonance block 312 may include the resonance groove 3121, the resonance block 313 may include the resonance groove 3131, the resonance block 314 may include the resonance groove 3141, the resonance block 315 may include the resonance groove 3151, the resonance block 316 may include the resonance groove 3161, and the resonance block 317 may include the resonance groove 3171.

The plurality of resonance blocks 311, 312, 313, 314, 315, 316, and 317 may be positioned at one side (e.g., based on a positive y-axis direction in FIG. 4) based on the centerline C-C′ of the filter housing 300.

The second filter 320 may include a plurality of resonance blocks 321, 322, 323, 324, 325, and 326. The plurality of resonance blocks 321, 322, 323, 324, 325, and 326 may be respectively formed by a plurality of resonance grooves 3211, 3221, 3231, 3241, 3251, and 3261. The plurality of resonance grooves 3211, 3221, 3231, 3241, 3251, and 3261 may each be positioned on the upper surface of the filter housing 300 and provided in the form of a groove having a predetermined depth from the upper surface of the filter housing 300. The resonance block 321 may include the resonance groove 3211, the resonance block 322 may include the resonance groove 3221, the resonance block 323 may include the resonance groove 3231, the resonance block 324 may include the resonance groove 3241, the resonance block 325 may include the resonance groove 3251, and the resonance block 326 may include the resonance groove 3261.

The plurality of resonance blocks 321, 322, 323, 324, 325, and 326 may be positioned at the other side (e.g., based on a negative y-axis direction in FIG. 4) opposite to one side (e.g., based on the positive y-axis direction in FIG. 4) based on the centerline C-C′ of the filter housing 300.

FIG. 4 illustrates dotted lines 3115, 3125, 3135, 3145, 3155, 3165, 3175, 3215, 3225, 3235, 3245, 3255, and 3265 for distinguishing between the plurality of resonance blocks 311, 312, 313, 314, 315, 316, and 317 and the plurality of resonance blocks 321, 322, 323, 324, 325, and 326. However, the dotted lines are provided to explain the embodiment and do not limit structures, shapes, and the like of the resonance blocks.

The number of filter stages of the first filter 310 illustrated in FIG. 4 may be seven, and the number of filter stages of the second filter 320 may be six.

The description of the waveguide filter 10 according to the embodiment may be equally applied to the waveguide filter 20 according to another embodiment and the waveguide filter 30 according to still another embodiment.

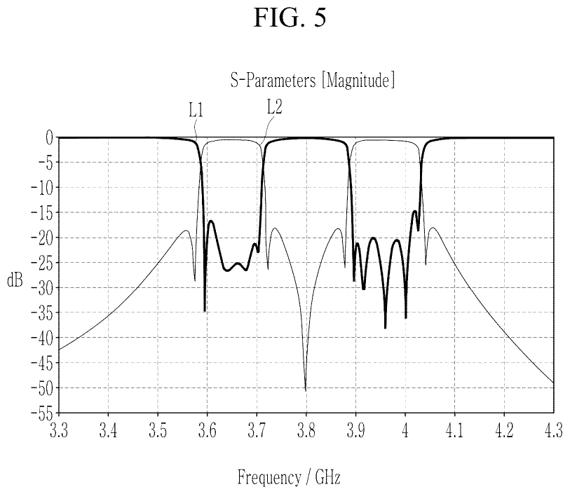

FIG. 5 is a graph for explaining electrical properties of the waveguide filter according to the embodiment.

With reference to FIG. 5, the graph shows vertical axis S parameter values (dB) with respect to horizontal axis frequencies (GHz). The S parameter refers to a ratio of an output voltage to an input voltage at a particular frequency. L1 represents a return loss, and L2 represents an injection loss. The return loss may refer to a ratio between a voltage (input voltage) of a signal, which is inputted to the input port hole 131 at a particular frequency, and a voltage (reflected voltage) reflected from the input port hole 131. The injection loss may refer to a ratio between a voltage (input voltage) of a signal, which is inputted to the input port hole 131 at a particular frequency, and a voltage outputted from the output port hole 141.

Because the waveguide filter 10 is a dual-band filter, the waveguide filter may transmit two filter bands. According to L1 and L2 illustrated in FIG. 5, it can be seen that the waveguide filter 10 according to the embodiment may transmit a first filter band with a frequency band of about 3.6 GHz to about 3.7 GHz and transmit a second filter band with a frequency band of about 3.9 GHz to about 4.0 GHz.

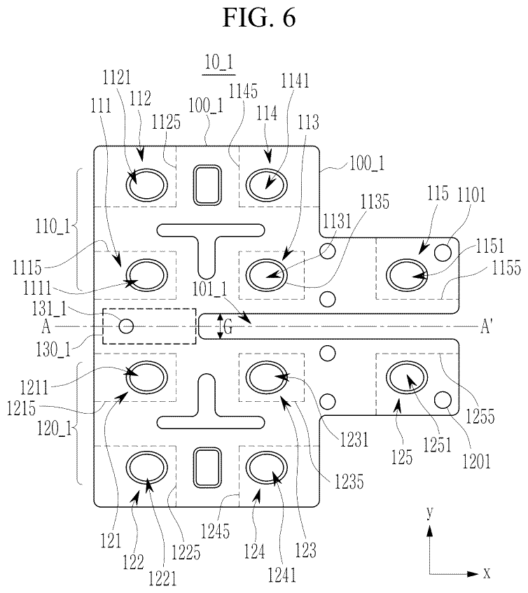

FIG. 6 is a top plan view of a duplexer according to the embodiment.

The components, which are not separately described below among components of a duplexer 10_1 according to the embodiment, may be identical to the components corresponding to the components of the waveguide filter 10 illustrated in FIG. 1.

The duplexer 10_1 may include a filter housing 100_1, a transmitting filter 110_1, a receiving filter 120_1, a common junction 130_1, an antenna port hole 131_1, a transmitting port hole 1101, and a receiving port hole 1201.

The duplexer 10_1 according to the embodiment includes an antenna port hole 130_1, the transmitting port hole 1101, and the receiving port hole 1201 one by one. The duplexer 10_1 may require a junction connected to the transmitting port hole 1101 and the receiving port hole 1201 from the single antenna port hole 130_1. Therefore, the duplexer 10_1 according to the embodiment may include the single common junction 130_1.

The common junction 130_1 may include the antenna port hole 130_1. The common junction 130_1 may be positioned in one region between the transmitting filter 110_1 and the receiving filter 120_1 in the filter housing 100_1.

With reference to FIG. 6, the filter housing 100_1 may include an opening portion 101_1. The opening portion 101_1 may be a perforated region between the transmitting filter 110_1 and the receiving filter 120_1. The opening portion 101_1 may position the transmitting filter 110_1 and the receiving filter 120_1 at a predetermined gap G. The opening portion 101_1 may have a predetermined length and a predetermined width in a longitudinal direction of the centerline A-A′.

The centerline A-A′ may be an imaginary line that passes through a center of the antenna port hole 130_1 on an upper surface of the filter housing 100_1. In the example in FIG. 6, the centerline A-A′ is parallel to the x-axis direction.

The transmitting filter 110_1 may be positioned in one direction (e.g., a positive y-axis direction in FIG. 6) based on the centerline A-A′ in the filter housing 100_1. The receiving filter 120_1 may be positioned in the other direction (e.g., a negative y-axis direction in FIG. 6) opposite to one direction (e.g., the positive y-axis direction in FIG. 6) based on the centerline A-A′ in the filter housing 100_1.

The transmitting filter 110_1 may include the transmitting port hole 1101, and the receiving filter 120_1 may include the receiving port hole 1201.

A signal may be inputted to the transmitting port hole 1101. A signal may be outputted from the receiving port hole 1201. The antenna port hole 130_1 may be a common port and transmit a signal, which is inputted to the transmitting port hole 1101, to an antenna. The antenna port hole 130_1 may transmit a signal, which is received from the antenna, to the receiving port hole 1201.

The antenna port hole 130_1 may be positioned at one side of the filter housing 100_1 (e.g., based on a negative x-axis direction in FIG. 6). The transmitting port hole 1101 may be positioned at the other side (e.g., based on a positive x-axis direction in FIG. 6) opposite to one side (e.g., based on the negative x-axis direction in FIG. 6) corresponding to the position of the antenna port hole 130_1 in the transmitting port 110_1. The receiving port hole 1201 may be positioned at the other side (e.g., based on the positive x-axis direction in FIG. 6) opposite to one side (e.g., based on the negative x-axis direction in FIG. 6) corresponding to the position of the antenna port hole 130_1 in the receiving port 120_1.

The antenna port hole 130_1, the transmitting port hole 1101, and the receiving port hole 1201 are perforated.

The transmitting filter 110_1 may further include the plurality of resonance blocks 111, 112, 113, 114, and 115. The plurality of resonance blocks 111, 112, 113, 114, and 115 may be respectively formed by the plurality of resonance grooves 1111, 1121, 1131, 1141, and 1151. The plurality of resonance grooves 1111, 1121, 1131, 1141, and 1151 may each be positioned on the upper surface of the filter housing 100_1 and provided in the form of a groove having a predetermined depth from the upper surface of the filter housing 100_1. The resonance block 111 may include the resonance groove 1111, the resonance block 112 may include the resonance groove 1121, the resonance block 113 may include the resonance groove 1131, the resonance block 114 may include the resonance groove 1141, and the resonance block 115 may include the resonance groove 1151.

The plurality of resonance blocks 111, 112, 113, 114, and 115 may be positioned at one side (e.g., based on the positive y-axis direction in FIG. 3) based on the centerline A-A′ of the filter housing 100_1.

The receiving filter 120_1 may further include the plurality of resonance blocks 121, 122, 123, 124, and 125. The plurality of resonance blocks 121, 122, 123, 124, and 125 may be respectively formed by the plurality of resonance grooves 1211, 1221, 1231, 1241, and 1251. The plurality of resonance grooves 1211, 1221, 1231, 1241, and 1251 may each be positioned on the upper surface of the filter housing 100_1 and provided in the form of a groove having a predetermined depth from the upper surface of the filter housing 100_1. The resonance block 121 may include the resonance groove 1211, the resonance block 122 may include the resonance groove 1221, the resonance block 123 may include the resonance groove 1231, the resonance block 124 may include the resonance groove 1241, and the resonance block 125 may include the resonance groove 1251.

The plurality of resonance blocks 121, 122, 123, 124, and 125 may be positioned at the other side (e.g., based on the negative y-axis direction in FIG. 3) opposite to one side (e.g., based on the positive y-axis direction in FIG. 3) based on the centerline A-A′ of the filter housing 100_1.

In the present specification, the duplexer 10_1 in FIG. 6 corresponding to the waveguide filter 10 in FIG. 1 has been described, but this is provided for convenience of description, and the present disclosure is not limited thereto. The duplexer according to any embodiment may include only the single common junction corresponding to the waveguide filters 20 and 30 illustrated in FIGS. 3 and 4. One of the two filters may be implemented as the transmitting filter, and the remaining filter may be implemented as the receiving filter. In this case, the common junction may include the antenna port hole, the transmitting filter may include the transmitting port hole, and the receiving filter may include the receiving port hole. In this case, the transmitting port hole and the receiving port hole may be positioned in the direction opposite to the position of the antenna port hole in the filter housing of the duplexer.

While the embodiments of the present disclosure have been described in detail above, the protection scope of the present disclosure is not limited thereto, various alterations and modifications may be made by those skilled in the art, and these alterations and modifications belong to the protection scope of the present disclosure.

### DESCRIPTION OF SYMBOLS

10, 20, 30: Waveguide filter
100, 200, 300: Filter housing
101, 201, 301: Opening portion
110, 120, 210, 220, 310, 320: Filter
111, 112, 113, 114, 115, 121, 122, 123, 124, 125, 211, 212, 213, 214, 215, 216, 221, 222, 223, 224, 225, 226, 311, 312, 313, 314, 315, 316, 317, 321, 322, 323, 324, 325, 326: Resonance block
1111, 1121, 1131, 1141, 1151, 1211, 1221, 1231, 1241, 1251, 2111, 2121, 2131, 2141, 2151, 2161, 2211, 2221, 2231, 2241, 2251, 2261, 3111, 3121, 3131, 3141, 3151, 3161, 3171, 3211, 3221, 3231, 3241, 3251, 3261: Resonance groove
1115, 1125, 1135, 1145, 1155, 1215, 1225, 1235, 1245, 1255, 2115, 2125, 2135, 2145, 2155, 2165, 2215, 2225, 2235, 2245, 2255, 2265, 3115, 3125, 3135, 3145, 3155, 3165, 3175, 3215, 3225, 3235, 3245, 3255, 3265: Dotted line
130, 230, 330: Input common junction
1301, 1302: Partial region
131, 231, 331: Input port hole
140, 240, 340: Output common junction
1401, 1402: Partial region
141, 241, 341: Output port hole
10_1: Duplexer
100_1: Filter housing
110_1: Transmitting filter
1101: Transmitting port hole
1201: Receiving filter
1201: Receiving port hole
130_1: Common junction
131_1: Antenna port hole

What is claimed is:

1. A dual-band waveguide filter comprising:
a filter housing;
an input common junction comprising an input port hole positioned at one side of the filter housing;
an output common junction comprising an output port hole positioned at the other side of the filter housing and positioned to be opposite to the input port hole; and
two filters positioned to be spaced apart from each other at a predetermined gap in an alignment direction of the input port hole and the output port hole in the filter housing and connected by the input common junction and the output common junction,
wherein a signal is inputted to the input port hole, and a signal is outputted from the output port hole.

2. The dual-band waveguide filter of claim 1, wherein:
the two filters comprise a first filter and a second filter, and
wherein the input common junction and the output common junction each comprise:
a first partial region provided on the filter housing and extending in a direction from the first filter toward the second filter; and
a second partial region provided on the filter housing and extending to be opposite to the first partial region in a direction from the second filter toward the first filter.

3. The dual-band waveguide filter of claim 1, wherein:
the filter housing comprises an opening portion perforated between the two filters, and
wherein the opening portion has a predetermined length and a predetermined width in a longitudinal direction of an imaginary line that passes through a center of the input port hole and a center of the output port hole.

4. The dual-band waveguide filter of claim 1, wherein:
the two filters each comprise a plurality of resonance blocks.

5. The dual-band waveguide filter of claim 4, wherein:
the plurality of resonance blocks each comprise a resonance groove provided in the form of a groove having a predetermined depth from an upper surface of the filter housing.

6. A dual-band waveguide filter comprising:
a filter housing;
a first filter comprising a plurality of first resonance blocks positioned at one side in the filter housing;
a second filter comprising a plurality of second resonance blocks positioned at the other side opposite to one side in the filter housing;
an input common junction positioned in a first region between the first filter and the second filter in the filter housing and comprising an input port to which a signal is inputted; and
an output common junction positioned in a second region between the first filter and the second filter in the filter housing and comprising an output port from which a signal is outputted,
wherein the first region and the second region are positioned to be spaced apart from each other.

7. The dual-band waveguide filter of claim 6, wherein:
the input common junction and the output common junction each comprise:
a first partial region provided on the filter housing and extending in a direction from the first filter toward the second filter; and
a second partial region provided on the filter housing and extending to be opposite to the first partial region in a direction from the second filter toward the first filter.

8. The dual-band waveguide filter of claim 6, wherein:
the first filter and the second filter are spaced apart from each other at a predetermined gap.

9. The dual-band waveguide filter of claim 8, wherein:
the filter housing comprises an opening portion perforated between the first filter and the second filter, and
wherein the opening portion has a predetermined length and a predetermined width in a longitudinal direction of an imaginary line that passes through a center of the input port hole and a center of the output port hole.

10. The dual-band waveguide filter of claim 6, wherein:
the plurality of first resonance blocks and the plurality of second resonance blocks each comprise a resonance groove provided in the form of a groove having a predetermined depth from an upper surface of the filter housing.

11. A duplexer comprising:
a filter housing;
a common junction comprising an antenna port hole positioned at one side of the filter housing;
a transmitting filter positioned in one direction based on a centerline, which passes through a center of the antenna port hole in the filter housing, the transmitting filter comprising a transmitting port hole; and
a receiving filter positioned to be spaced apart from the transmitting filter at a predetermined gap in the other direction opposite to one direction based on the centerline, the receiving filter comprising a receiving port hole.

12. The duplexer of claim 11, wherein:
the filter housing comprises an opening portion perforated between the transmitting filter and the receiving filter, and
wherein the opening portion has a predetermined length and a predetermined width in a longitudinal direction of the centerline.

13. The duplexer of claim 11, wherein:
the transmitting filter and the receiving filter each comprise a plurality of resonance blocks.

14. The duplexer of claim 13, wherein:
the plurality of resonance blocks each comprise a resonance groove provided in the form of a groove having a predetermined depth from an upper surface of the filter housing.
